(19) United States
(12) Patent Application Publication
(10) Pub. No.: US 2023/0161891 A1
(43) Pub. Date: May 25, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Takuya DEGUCHI, Kanagawa (JP)

(73) Assignee: FUJIFILM Business Innovation Corp., Tokyo (JP)

(21) Appl. No.: 17/718,334

(22) Filed: Apr. 12, 2022

(30) Foreign Application Priority Data
Nov. 25, 2021 (JP) 2021-191590

(51) Int. Cl. G06F 21/62; G06F 21/60

(52) U.S. Cl. CPC G06F 21/6218; G06F 21/604; G06F 2221/2141

(57) ABSTRACT

An information processing apparatus includes: a processor configured to: acquire a confidentiality value indicating a degree of confidentiality of a file on which an operation request is performed, by using at least one of an attribute of a user who performs the operation request on the file or file information of the file on which the operation request is performed; and execute a process corresponding to the confidentiality value, on the file on which the operation request is performed, according to a predetermined regulation in which the confidentiality value and a process for the file are associated with each other.

### CROSS-REFERENCE TO RELATED APPLICATIONS

This application is based on and claims priority under 35 USC 119 from Japanese Patent Application No. 2021-191590 filed Nov. 25, 2021.

### BACKGROUND

### (i) Technical Field

The present invention relates to an information processing apparatus, a non-transitory computer readable medium storing an information processing program, and an information processing method.

### (ii) Related Art

JP2015-133087A discloses a file management apparatus including a security level setting section that sets a first security level of a file created by a user based on characteristics of the file, an optimum security level determining section that determines an optimum security level appropriate for the file based on a second security level set for the file by the user and the first security level set by the security level setting section, and a process execution section that executes a process related to the file based on the optimum security level determined by the optimum security level determining section.

### SUMMARY

Access rights may be set in advance for a user and a file so that the user may not freely access the files.

In this case, since a file operation is performed according to the set access right, the same process is executed for each operation request of the file, so it is not possible to flexibly change the permission or non-permission of an authority for operating the file, in accordance with contents of the file having an operation request or a user who makes the operation request.

Aspects of non-limiting embodiments of the present disclosure relate to an information processing apparatus, a non-transitory computer readable medium storing an information processing program, and an information processing method that control a process on a requested file, for each operation request of the file.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to: acquire a confidentiality value indicating a degree of confidentiality of a file on which an operation request is performed, by using at least one of an attribute of a user who performs the operation request on the file or file information of the file on which the operation request is performed; and execute a process corresponding to the confidentiality value, on the file on which the operation request is performed, according to a predetermined regulation in which the confidentiality value and a process for the file are associated with each other.

### BRIEF DESCRIPTION OF THE DRAWINGS

Exemplary embodiment(s) of the present invention will be described in detail based on the following figures, wherein:

FIG. 1 is a diagram illustrating a configuration example of a file management system;

FIG. 2 is a diagram illustrating a functional configuration example of a file management apparatus;

FIG. 3 is a diagram illustrating a data structure example of a user DB;

FIG. 4 is a diagram illustrating a data structure example of a file DB;

FIG. 5 is a diagram illustrating a data structure example of a conditional equation DB;

FIG. 6 is a diagram illustrating an example of a setting screen of a conditional equation;

FIG. 7 is a diagram illustrating a data structure example of a rule DB;

FIG. 8 is a diagram illustrating an example of a setting screen of a rule;

FIG. 9 is a diagram illustrating a main portion configuration example of an electric system of the file management apparatus;

FIG. 10 is a flowchart illustrating an example of a flow of a registration process in the file management apparatus;

FIG. 11 is a flowchart illustrating an example of a flow of an acquisition process in the file management apparatus; and

FIG. 12 is a diagram illustrating another example of the rule DB.

### DETAILED DESCRIPTION

Hereinafter, the present exemplary embodiment will be described with reference to the drawings. The same component and the same process are given the same reference numerals with reference to the drawings, and duplicate description will be omitted.

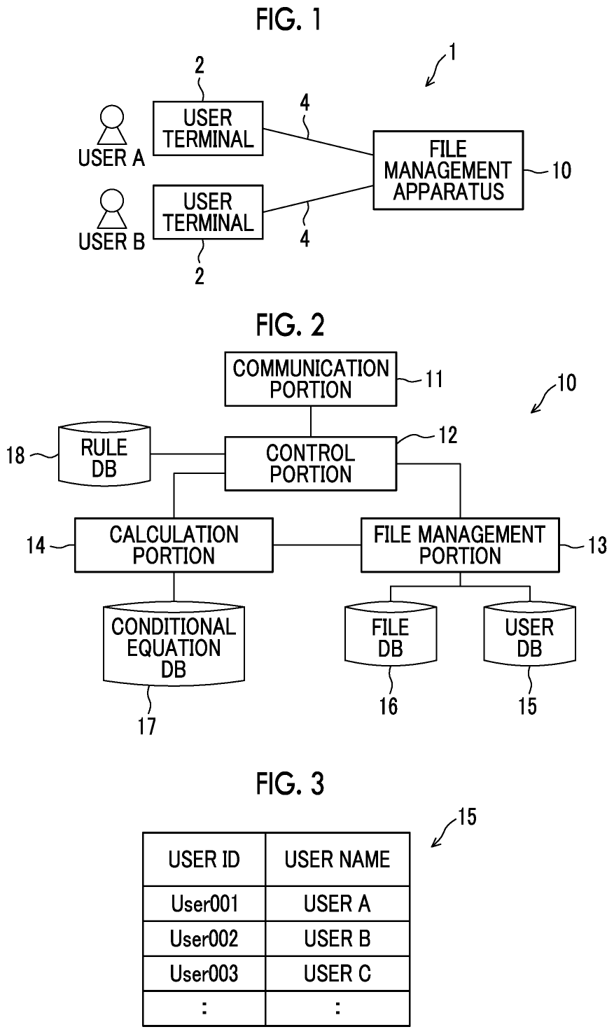

FIG. 1 is a diagram illustrating a configuration example of a file management system 1 that manages files. The “file” is one of management units of data in a computer, and is an aggregation of the data configured according to a predetermined format. The “management” is to execute operations on a file, such as storing, deleting, editing, moving, copying, and acquiring the file, according to an instruction of a user, for example.

As illustrated in FIG. 1, the file management system 1 includes at least one user terminal 2 and a file management apparatus 10. The user terminal 2 and the file management apparatus 10 are connected by a communication line 4. There are no restrictions on a connection form of the communication line 4, and the connection form of the communication line 4 may have a wired manner, a wireless manner, or a mixed form of wired and wireless. Further, the communication line 4 may be either a public line or a dedicated line.

The user terminal 2 is an information device used by each user (a user A and a user B in the example in FIG. 1). The user terminal 2 may be any type of information device as long as the user terminal 2 has at least one function of a data communication function through the communication line 4 and a function related to a file such as creating, editing, and browsing of the file. For example, as the user terminal 2, a computer, a smartphone, a tablet terminal, a wearable device, or the like is used. There is no limit to the number of user terminals 2 connected to the file management apparatus 10.

The file management apparatus 10 is an apparatus that stores a file received from the user terminal 2 through the communication line 4 in a storage device that may be read and written by the file management apparatus 10 (hereinafter, referred to as “registers”), and processes a file having an operation request among the registered files, according to an instruction of the user terminal 2 that is a request source.

As will be described later, without unconditionally processing a file having an operation request according to an instruction of the user terminal 2, each time the operation request is accepted, the file management apparatus 10 calculates a security level indicating the degree of confidentiality of the file, and determines whether or not to execute the requested operation according to the security level. Further, even in a case where the file management apparatus 10 executes the requested operation, the file management apparatus 10 determines whether or not to add some restrictions on the requested operation, in accordance with the security level, without executing the requested operation as it is.

FIG. 2 is a diagram illustrating a functional configuration example of the file management apparatus 10. The file management apparatus 10 includes each function section of a communication portion 11, a control portion 12, a file management portion 13, and the calculation portion 14, and each database of a user DB 15, a file DB 16, a conditional equation DB 17, and a rule DB 18. The “DB” is an abbreviation for a database. The database according to the present exemplary embodiment is not limited to, for example, a commercially available relational database or the like. As long as the database has a mechanism capable of storing a designated file in a storage device and reading the designated file from the storage device, there are no restrictions on a method of realizing the database.

The communication portion 11 transmits and receives data to and from the user terminal 2, according to an instruction of the control portion 12.

The control portion 12 interprets an operation request from the user terminal 2 received via the communication portion 11 and outputs an instruction in accordance with contents of the operation request to the communication portion 11, the file management portion 13, and the calculation portion 14 to execute file management.

The operation request received from the user terminal 2 includes, for example, a process related to a file such as registration of a designated file, deleting, editing, moving, copying, and acquiring of the file registered in the file management apparatus 10, and editing of attributes of the file.

The file attribute is information set by being added to the file, and is information represented by contents of the file, that is, information different from a body of the file. Specifically, the file attributes include, for example, a file name, a file creation date and time, a file size, and the like. The body of the file and the attribute of the file are examples of “file information” according to the present exemplary embodiment.

The file management portion 13 registers the designated file in the file DB 16, and acquires the designated file from the file DB 16.

In a case where a user transmits an operation request to the file management apparatus 10 through the user terminal 2, a user name of the user who makes the operation request is added to the operation request, and the user name of the user who owns the user terminal 2 is registered in the user DB 15 in advance.

FIG. 3 is a diagram illustrating an example of a data structure of the user DB 15. As illustrated in FIG. 3, in the user DB 15, a user name of a user who owns the user terminal 2 and a user ID uniquely associated with each user in advance are associated and stored for each user.

The file management portion 13 acquires information on the user who makes an operation request (in this case, the user ID) from the user DB 15 from the user name added to the operation request. As a matter of course, the user ID may be added to the operation request instead of the user name. In this case, the file management portion 13 may acquire the user name from the user DB 15 as information on the user who makes the operation request. Hereinafter, for example, the information on the user who makes the operation request is referred to as “user information”. The user information stored in the user DB 15 is not limited to the user name and the user ID, and may include various types of information associated with the user such as an age, a term of office, a department, and an address of the user, for example.

That is, the file management portion 13 acquires the user information of the user who makes the operation request from the user DB 15. The user information is an example of an “attribute of user” according to the present exemplary embodiment.

In a case where the operation request received from the user terminal 2 is a registration request, the file management portion 13 registers a file designated in the registration request in the file DB 16.

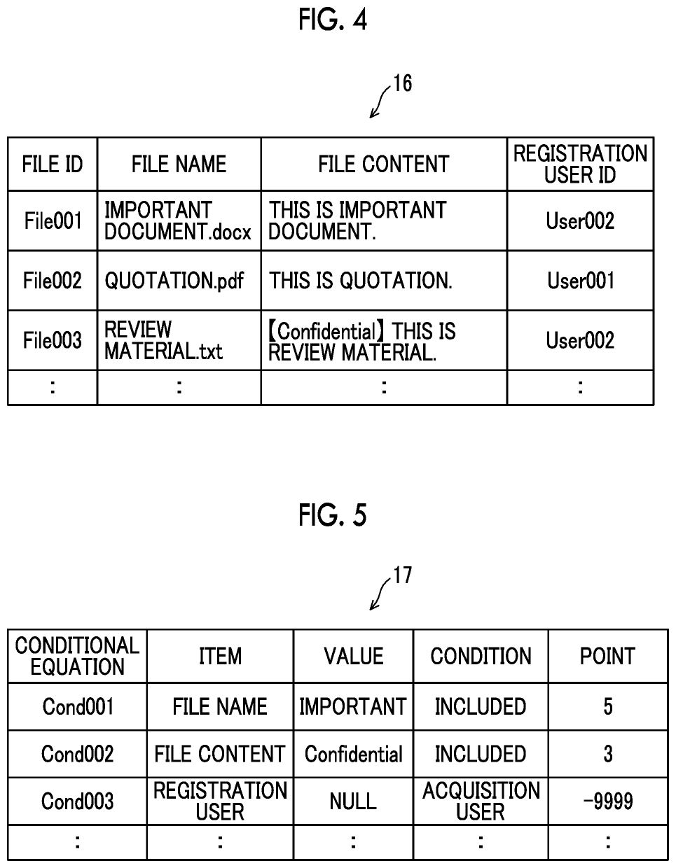

FIG. 4 is a diagram illustrating a data structure example of the file DB 16. As illustrated in FIG. 4, a file ID, a file name, a file content, and a registration user ID are associated with each file in the file DB 16.

The file ID is an identifier for uniquely identifying a file registered in the file DB 16.

The file name is a name of a file registered in the file management apparatus 10.

The file content is a body of the file, that is, information displayed by an application in a case where the application for browsing the content of the file is started.

The registration user ID is a user ID of a user (referred to as a “registration user”) who makes the registration request of the file, and for example, a user ID acquired from the user DB 15 is set based on the user name added to the operation request.

The file management portion 13 registers the file having the registration request in the file DB 16 in association with the file ID, the file name, the file content, and the registration user ID.

In a case where the file content is registered in the file DB 16, the file management portion 13 acquires, for example, entire data corresponding to the body of the file from the file, and sets the data as the file content, and a method of setting the file content is not limited to this. The file management portion 13 may extract at least one keyword from the body of the file, and set the keyword in the file content. Specifically, the file management portion 13 may set a keyword included in the body of the file, among predetermined keywords, in the file content. Further, the file management portion 13 may extract a word and phrase having an importance determined to be equal to or higher than a threshold value from the file, by a learning model in which a relationship between the word and phrase and the importance of the word and phrase in the body of the file is machine-learned, and set the word and phrase in the file content.

In addition, the file management portion 13 may set a summary of the body of the file in the file content. Specifically, the file management portion 13 may execute known natural language analysis such as morphological analysis, context analysis, and syntax analysis on the body of the file, and set the summary of the body of the file as the file content.

On the other hand, in a case where the operation request received from the user terminal 2 is an operation request other than the registration request, the file management portion 13 refers to a file name of the file designated as an operation target in the operation request, specifies the designated file, and performs the requested operation on the designated file according to an instruction of the control portion 12.

The calculation portion 14 acquires at least one of the user information of the user who makes the operation request for the file or the file information of the file designated as the operation request target from the control portion 12. Then, the calculation portion 14 acquires a conditional equation in which a security point is associated with at least one of a predetermined user condition as a condition related to user information or a predetermined file condition as a condition related to file information, from the conditional equation DB 17.

FIG. 5 is a diagram illustrating a data structure example of the conditional equation DB 17. As illustrated in FIG. 5, the conditional equation DB 17 is associated with a conditional equation ID, an item, a value, a condition, and a point, for each conditional equation.

The conditional equation ID is an identifier for uniquely identifying a conditional equation stored in the conditional equation DB 17.

The item represents a determination target for determining whether or not the conditional equation represented by the conditional equation ID is satisfied.

The value is a text string to be compared with the item, and a type of the text string set in the value is not limited. For example, alphabets, numbers, symbols, kanji, hiragana, katakana, and the like are used for the text string. In a case where the text string is not set in the value, a reserved text defined as “NULL” is set, for example, and the value may be maintained to be blank instead of “NULL”.

In a case where a text string is set in the value, a condition for determining a relationship between a determination target of the conditional equation designated in the item and the text string set in the value is set to a condition of the conditional equation DB 17. In a case where the text string is not set in the value, the item to be compared with the determination target of the conditional equation designated in the item is set in the condition of the conditional equation DB 17.

The point represents a security point given in a case where a condition represented by each conditional equation is established. The security point means that the higher the value, the more the requested operation has to be restricted.

For example, in a case where the operation request is an acquisition request of a file, the security point indicates a security level of the file having the acquisition request, that is, the degree of confidentiality of the file, since the acquisition of the file is restricted. Further, in a case where the operation request is a deletion request of the file, the security point indicates the degree of importance of the file having the deletion request since the deletion of the file is restricted. Since it may be considered that a file having a higher degree of confidentiality is a file having a higher degree of importance, an equivalence relation is seen between the degree of confidentiality of the file and the degree of importance of the file. As described above, the security point according to the present exemplary embodiment is an example of a “confidentiality value”. For convenience of description, the security point will be referred to as a “point” hereafter.

As described above, a conditional equation having a conditional equation ID of “Cond001” in FIG. 5 indicates that 5 points are given in a case where a text string “important” is included in a file name of a file as an operation target. In addition, a conditional equation having a conditional equation ID of “Cond002” in FIG. 5 indicates that 3 points are given in a case where a text string “Confidential” is included in a file content of a file as an operation target. Further, a conditional equation having a conditional equation ID of “Cond003” in FIG. 5 indicates that −9999 points are given in a case where a registration user who registers a file as an operation target in the file management apparatus 10 and a user who tries to operate the file (referred to as “operation user”) are the same user.

The point of a negative value is set in the conditional equation of which the conditional equation ID is represented by “Cond003”. This is because the user who tries to operate the file is estimated as a user who has a management authority for the file, for example, a creator of the file in a case where the user who registers the file in the file management apparatus 10 and the user who tries to operate the file are the same. In such cases, the point is set to the negative value since a need to limit the requested operation is considered to be relatively low. As a matter of course, the point associated with each conditional equation in FIG. 5 is an example, and an administrator sets the point in consideration of the degree of restriction applied to the operation.

The conditional equations of which the conditional equation IDs are represented by “Cond001” and “Cond002” in FIG. 5 are conditional equations in which the points are associated with a condition related to file information of the file as an operation target, that is, a file condition of the file as the operation target. On the other hand, the conditional equation of which the conditional equation ID is represented by “Cond003” in FIG. 5 is a conditional equation in which the point is associated with a condition related to user information of the user who makes the operation request, that is, a user condition of the user who makes the operation request.

Specifically, a file condition of the conditional equation of which the conditional equation ID is represented by “Cond001” in FIG. 5 is a condition that a text string used in a file name of the file having the operation request is defined. A file condition of the conditional equation of which the conditional equation ID is represented by “Cond002” in FIG. 5 is a condition that a text string used in a content of the file having the operation request is defined. Further, a user condition of the conditional equation of which the conditional equation ID is represented by “Cond003” in FIG. 5 is a condition that a relationship between the user who registers the file as the operation target and the user who makes the operation request of the file is defined.

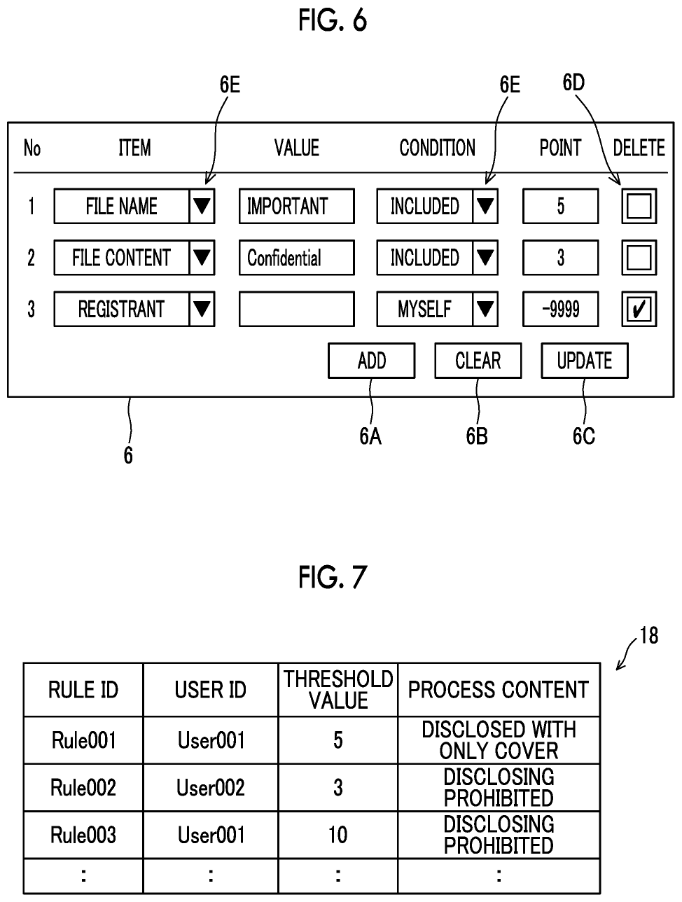

The conditional equation stored in the conditional equation DB 17 is created in advance by an administrator of the file management system 1 through, for example, a conditional equation setting screen 6 as illustrated in FIG. 6. As illustrated in FIG. 6, since the conditional equation setting screen 6 is provided with a conditional equation addition button 6A, the administrator may add a new line for creating a conditional equation to the conditional equation setting screen 6. In addition, since the conditional equation setting screen 6 is provided with a check box 6D for deleting a conditional equation, the administrator may delete the conditional equation for which the check box 6D is checked, by checking the check box 6D and selecting a clear button 6B. That is, the conditional equation stored in the conditional equation DB 17 may be increased or decreased by the administrator.

On the conditional equation setting screen 6, an item and a condition of the conditional equation may be selected from a pull-down menu 6E, and the administrator directly inputs a text string for a value and a point of the conditional equation. In a case where the administrator selects an update button 6C after creating a conditional equation, the created conditional equation is stored in the conditional equation DB 17. There are no restrictions on an input method of the conditional equation on the conditional equation setting screen 6, and the above input method is only an example.

As a matter of course, the conditional equation is not limited to the example of the conditional equation illustrated in FIG. 5. For example, by setting the item as “registration date and time”, the value as “12 months”, the condition as “elapse”, and the point as “2”, a conditional equation to which 2 points are given may be created in a case where 12 months elapse from a registration date and time at which a file as an operation target is registered in the file management apparatus 10. That is, the conditional equation DB 17 may include a conditional equation regarding the registration time of the file.

Further, in a case where the item is set to “storage location”, the value is set to “NULL”, the condition is set to “folder 1”, and the point is set to “1”, a conditional equation to which 1 point is given may be created in a case where a storage location of a file as an operation target in the file DB 16 is a folder 1. That is, the conditional equation DB 17 may include a conditional equation regarding the storage location of the file.

In addition, by setting the item to “last file acquisition date and time”, the value to “1 hour”, the condition to “before elapse”, and the point to “1”, a conditional equation to which 1 point is given may be created in a case where one hour or more does not elapse after acquisition of a file as an operation target and the same user makes the acquisition request again. That is, the conditional equation DB 17 may include a conditional equation related to an operation frequency of the file.

The calculation portion 14 sequentially acquires each conditional equation stored in the conditional equation DB 17, determines whether or not the condition is satisfied for each conditional equation, and calculates a total value of points associated with each conditional equation that satisfies the condition.

On the other hand, the control portion 12 executes a process corresponding to the point calculated by the calculation portion 14 on a file having an operation request, according to a rule in which the point and the process on the file are associated with each other, which is a regulation stored in advance in the rule DB 18.

FIG. 7 is a diagram illustrating a data structure example of the rule DB 18. As illustrated in FIG. 7, a rule ID, a user ID, a threshold value, and a process content are associated with each rule in the rule DB 18.

The rule ID is an identifier for uniquely identifying a rule stored in the rule DB 18.

The user ID represents a user ID of a user to which the rule represented by the rule ID is applied.

The threshold value represents a lower limit value of points required to execute the process content associated with the rule represented by the rule ID.

The process content represents a content of a process executed in a case where a total value of points calculated by the calculation portion 14 of a file as an operation target becomes equal to or greater than the threshold value.

That is, the rule represented by the rule ID is defined for each user who makes an operation request of the file. In addition, a plurality of rules may be defined for the same user. Each rule represented by the rule ID is an example of a “predetermined regulation” according to the present exemplary embodiment.

The rule stored in the rule DB 18 exists for each type of operation, and as an example, FIG. 7 illustrates a rule corresponding to an acquisition process.

In FIG. 7, a rule having a rule ID represented by “Rule001” is a rule for a user having a user ID represented by “User001”, and in a case where a total value of points for an acquisition request of a file is equal to or more than 5 points, only a cover page of the file is disclosed. In addition, a rule having a rule ID represented by “Rule002” is a rule for a user having a user ID represented by “User002”, and in a case where a total value of points for an acquisition request of a file is equal to or more than 3 points, the file is not disclosed. Further, a rule having a rule ID represented by “Rule003” is a rule for the user having the user ID represented by “User001”, and in a case where a total value of points for an acquisition request of a file is equal to or more than 10 points, the file is not disclosed.

In a case where the point for the operation request is equal to or more than a threshold value defined in the rule, the rule is said to be “established”.

In a case where a plurality of rules are established for the user who makes the operation request of the file, the control portion 12 follows the rule in which a process with which the highest threshold value is associated is defined, among the established rules, and executes the process defined in the rule.

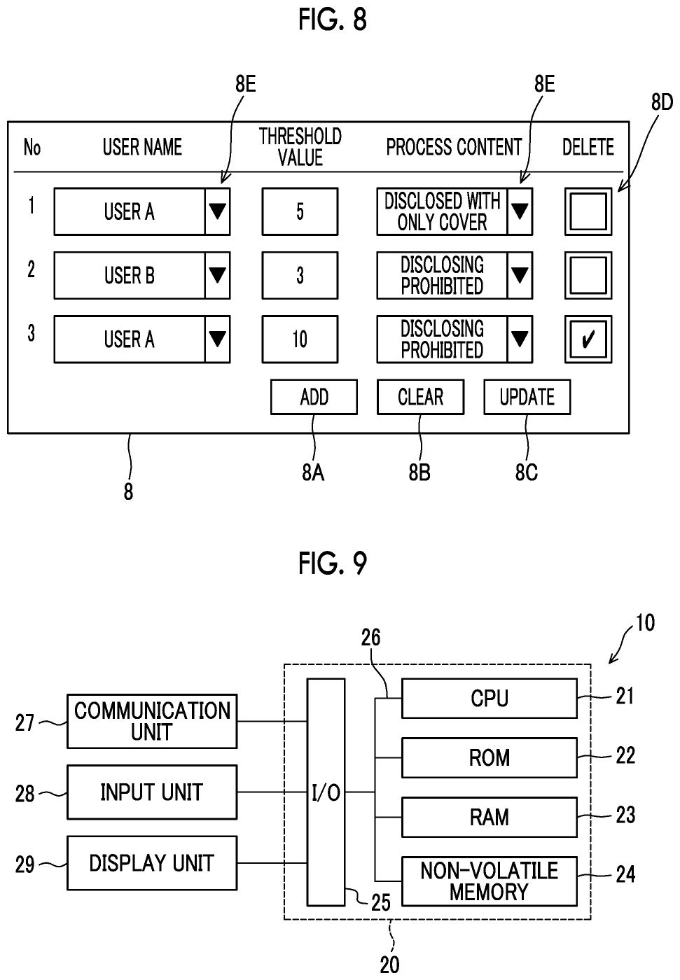

The rule stored in the rule DB 18 is created by an administrator of the file management system 1 through, for example, a rule setting screen 8 as illustrated in FIG. 8. As illustrated in FIG. 8, since the rule setting screen 8 is provided with a rule addition button 8A, the administrator may add a new line for creating a rule to the rule setting screen 8. In addition, since the rule setting screen 8 is provided with a check box 8D for deleting a rule, the administrator may delete a rule for which the check box 8D is checked, by checking the check box 8D and selecting a clear button 8B. That is, the rule stored in the rule DB 18 may be increased or decreased by the administrator.

On the other hand, a user name and a process content in the rule may be selected from a pull-down menu 8E, and the administrator directly inputs a value for a threshold value in the rule. In a case where the administrator selects an update button 8C after creating the rule, the created rule is stored in the rule DB 18. There are no restrictions on an input method of the rule on the rule setting screen 8, and the above input method is only an example.

Next, a main portion configuration example of an electric system of the file management apparatus 10 will be described with reference to FIG. 9. The file management apparatus 10 is configured by using, for example, a computer 20.

The computer 20 includes a central processing unit (CPU) 21, a read only memory (ROM) 22, a random access memory (RAM) 23, a non-volatile memory 24, and an input and output interface (I/O) 25, and the CPU 21, the ROM 22, the RAM 23, the non-volatile memory 24, and the I/O 25 are connected to each other via a bus 26.

The CPU 21 is an example of a processor that handles a process of each functional portion of the file management apparatus 10 illustrated in FIG. 2. The ROM 22 is an example of a storage medium for storing an information processing program executed by the CPU 21. The RAM 23 is an example of a storage medium used as a temporary work area of the CPU 21.

The non-volatile memory 24 is an example of a storage medium in which stored information is maintained even in a case where a power supplied to the non-volatile memory 24 is cut off. For example, a semiconductor memory is used, and a hard disk may be used. The user DB 15, the file DB 16, the conditional equation DB 17, and the rule DB 18 according to the present exemplary embodiment will be described as being built in the non-volatile memory 24, and may be built in an external apparatus (not illustrated) such as a data server connected to the communication line 4. In this case, the CPU 21 transmits and receives various types of data including files to and from the external apparatus through a communication unit 27.

The non-volatile memory 24 does not necessarily have to be built in the computer 20, and may be a storage medium that is attached to and detached from the computer 20, such as a memory card or a Universal Serial Bus (USB) memory, for example.

For example, the communication unit 27, an input unit 28, and a display unit 29 are connected to the I/O 25.

The communication unit 27 includes a communication protocol that is connected to the communication line 4, and transmits and receives data to and from the user terminal 2 connected to the communication line 4 and the external apparatus.

The input unit 28 is a device that receives an instruction from an administrator and notifies the CPU 21, and includes, for example, a button, a touch panel, a mouse, a keyboard, and a pointing device. The administrator may set a conditional equation and a rule through the input unit 28.

The display unit 29 is an example of a display device that displays information processed by the CPU 21 as an image, and includes, for example, a liquid crystal display or an organic electro luminescence (EL) display or the like. The conditional equation setting screen 6 illustrated in FIG. 6 and the rule setting screen 8 illustrated in FIG. 8 are displayed on the display unit 29.

The administrator may also set a conditional equation and a rule from a remote location using the external apparatus. In this case, the conditional equation setting screen 6 illustrated in FIG. 6 and the rule setting screen 8 illustrated in FIG. 8 are displayed on the external apparatus, and the administrator sets the conditional equation and the rule from the external apparatus. Therefore, the input unit 28 and the display unit 29 are not necessarily fundamental units for the file management apparatus 10. Further, another unit may be connected to the I/O 25 as needed. For example, an image forming unit such as a printer may be connected to the I/O 25 so as to print various types of data stored in the user DB 15, the file DB 16, the conditional equation DB 17, and the rule DB 18 on paper.

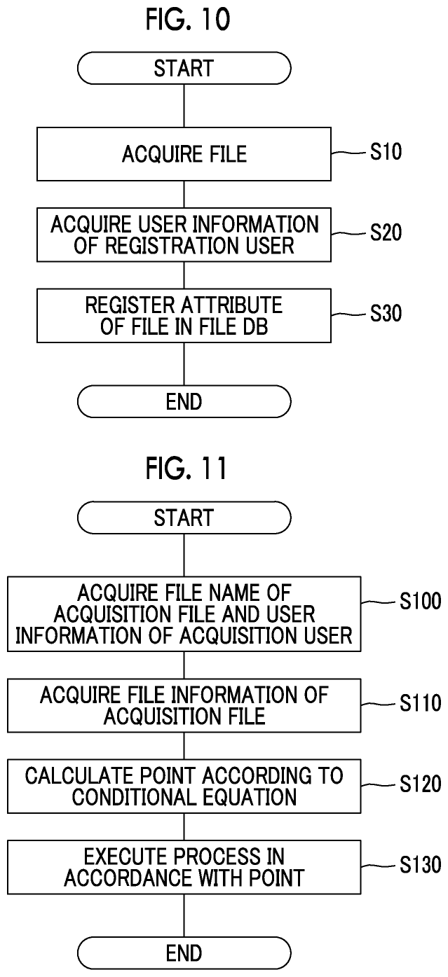

Next, an action of the file management apparatus 10 will be described. FIG. 10 is a flowchart illustrating an example of a flow of a registration process executed by the CPU 21 in a case where a registration request of a file is received from the user terminal 2. An information processing program that defines the registration process is stored in advance in, for example, the ROM 22 of the file management apparatus 10. The CPU 21 of the file management apparatus 10 reads the information processing program stored in the ROM 22, and executes the registration process.

For convenience of description, it is assumed that together with a file as a registration target, a user name of a registration user is added as user information to the registration request of the file received from the user terminal 2.

In step S10 in FIG. 10, the CPU 21 acquires a file received together with a registration request, and stores the file in the RAM 23.

In step S20, the CPU 21 acquires user information of a registration user added to the registration request, and stores the user information in the RAM 23.

In step S30, the CPU 21 refers to the user DB 15, and acquires a user ID corresponding to a user name included in the user information acquired in step S20. In the example of the user DB 15 illustrated in FIG. 3, in a case where the user name included in the user information is the “user A”, the CPU 21 acquires “User001” as the user ID.

Further, the CPU 21 extracts file information of the file acquired in step S10, and stores a new file ID that does not overlap with file IDs of other files previously registered in the file DB 16, the file information extracted from the file as a registration target, and the user ID of the registration user in the file DB 16 in association with the file as the registration target.

In a case of the file DB 16 illustrated in FIG. 4, the CPU 21 extracts a file name and a file content as the file information. That is, the file information extracted from the file as the registration target follows an item of file information defined to be stored in the file DB 16.

As a result, the registration process illustrated in FIG. 10 is completed. The CPU 21 may transmit a registration completion notification to the user terminal 2 that requests the file registration to notify that the file registration is completed. The file ID and the file name of the file registered in the file management apparatus 10 are opened to each user terminal 2 through, for example, a Web page.

Next, as an example of an operation request for a file, an acquisition process of the file in a case where an acquisition request of the file is received from the user terminal 2 will be described.

FIG. 11 is a flowchart illustrating an example of a flow of an acquisition process executed by the CPU 21 in a case where a file acquisition request is accepted from the user terminal 2. In the same manner as the registration process illustrated in FIG. 10, a process content is defined by an information processing program, and the CPU 21 reads the information processing program stored in the ROM 22, and executes the acquisition process.

In step S100 in FIG. 11, the CPU 21 acquires a file name of a file as an acquisition target (referred to as “acquisition file”) requested by an acquisition request, and acquires user information of a user who makes the acquisition request (referred to as “acquisition user”) from the acquisition request, and store the file name and the user information in the RAM 23.

In step S110, the CPU 21 refers to the user DB 15, and acquires a user ID corresponding to the user name of the acquisition user included in the user information acquired in step S100. Further, the CPU 21 acquires file information of the acquisition file from the file DB 16 based on the file name acquired in step S100.

The acquisition user may include a file ID of the acquisition file in the acquisition request instead of the file name of the acquisition file. In this case, the CPU 21 acquires the file information of the acquisition file from the file DB 16, based on the file ID.

In step S120, the CPU 21 acquires all conditional equations stored in the conditional equation DB 17. The CPU 21 uses the user information of the acquisition user and the file information of the acquisition file to determine whether or not a condition represented by the conditional equation is satisfied for each conditional equation. Then, the CPU 21 calculates a total value of points associated with each conditional equation that satisfies the condition.

For example, it is assumed that the conditional equation DB 17 stores three conditional equations represented by respective conditional equation IDs of “Cond001”, “Cond002”, and “Cond003” illustrated in FIG. 5. In this case, a point in a case where the user A makes an acquisition request of “important document.docx” having a file ID represented by “File001” as an acquisition user (referred to as “CASE 1”) will be examined.

A file name of “important document.docx” includes a text string of “important”. Therefore, a condition represented by the conditional equation of “Cond001” is satisfied.

Further, as illustrated in FIG. 4, a file content of “important document.docx” does not include a text string “Confidential”. Therefore, a condition represented by the conditional equation of “Cond002” is not satisfied.

Further, as illustrated in FIG. 4, a user ID of the registration user of “important document.docx” is “User002”. On the other hand, since a user ID of the acquisition user is “User001” with reference to the user DB 15 illustrated in FIG. 3, the registration user of “important document.docx” is different from the acquisition user. Therefore, a condition represented by the conditional equation of “Cond003” is not satisfied.

From the above results, the CPU 21 calculates 5 points associated with the conditional equation of “Cond001” that satisfies the condition as points for the acquisition request.

Further, the points in a case where the user B makes an acquisition request of “review material.txt” having a file ID represented by “File003” as an acquisition user (referred to as “case 2”) will be examined.

A file name of “review material.txt” does not include a text string of “important”. Therefore, a condition represented by the conditional equation of “Cond001” is not satisfied.

Further, as illustrated in FIG. 4, a file content of “review material.txt” includes a text string of “Confidential”. Therefore, a condition represented by the conditional equation of “Cond002” is satisfied.

Further, as illustrated in FIG. 4, a user ID of the registration user of “review material.txt” is “User002”. On the other hand, since a user ID of the acquisition user is also “User002” with reference to the user DB 15 illustrated in FIG. 3, the registration user of “review material.txt” is the same user as the acquisition user. Therefore, a condition represented by the conditional equation of “Cond003” is satisfied.

From the above results, the CPU 21 calculates −9996, which is a total value of 3 points and −9999 points respectively associated with the conditional equations of “Cond002” and “Cond003” that satisfy the conditions, as points for the acquisition request.

In a case where there is no conditional equation that satisfies the condition, the CPU 21 does not determine the point.

After calculating the point for the acquisition request in this manner, in step S130 in FIG. 11, the CPU 21 executes the process corresponding to the point for the acquisition request.

Therefore, the CPU 21 refers to a rule for the acquisition request stored in the rule DB 18, and acquires a rule for which the point for the acquisition request is equal to or higher than a threshold value, that is, an established rule, among the rules with which the user ID of the acquisition user is associated. As described above, in a case where there are a plurality of established rules, the CPU 21 selects a rule with which the highest threshold value is associated, among the established rules.

Then, the CPU 21 executes the process content associated with the acquired rule.

For example, it is assumed that the rule DB 18 stores three rules represented by the respective rule IDs of “Rule001”, “Rule002”, and “Rule003” illustrated in FIG. 7.

In a case of CASE 1 described above, since the user ID of the acquisition user is “User001” and the point for the acquisition request is 5 points, the CPU 21 discloses only the process content associated with the rule having the rule ID of “Rule001”, that is, a cover of the file as an acquisition target (in this case, “important document.docx”).

Further, in a case of CASE 2 described above, since the user ID of the acquisition user is “User002” and the point for the acquisition request is −9996 points, there is no established rule in the rule DB 18. In such a case, the CPU 21 discloses the entire file as the acquisition target (in this case, “review material.txt”).

In a case where the point for the file operation request is undetermined, any condition represented by any conditional equation is not satisfied, so it is possible that there is a problem with a setting content of the conditional equation. Therefore, in a case where the point is not determined, the CPU 21 imposes the strictest restriction on the operation on the file (in this case, the acquisition of the file) based on the idea of fail-safe. Further, in a case where the user ID of the acquired user does not coincide with any user ID defined in the rule DB 18, there is a possibility of unauthorized access. Therefore, even in a case where the user ID does not coincide with any of the user ID defined in the rule DB 18, the CPU 21 imposes the strictest restriction on the operation of the file. That is, in a case where the file operation request is a file acquisition request, the CPU 21 executes a process of prohibiting disclosure of the file in any case.

A method of disclosing a file is a method of transmitting the file in a range permitted to be disclosed according to a rule to the user terminal 2 that is a transmission source of an acquisition request, and may be any method of controlling the file to display only in a range in which the disclosure is permitted for each acquisition user in a case where the file requested to be acquired from the user terminal 2 is disclosed to the acquisition user by displaying the file on a Web page, for example.

As a result, the acquisition process illustrated in FIG. 11 is completed.

For other types of operations such as deleting, editing, moving, and copying a file, for example, for deleting the file, in a case where the administrator sets a process content and a threshold value corresponding to each operation in the rule DB 18, such as prohibiting deletion in a case where a point is equal to or more than 8 points, it is possible to limit the operation of the file in response to various operation requests.

Although the rule DB 18 illustrated in FIG. 7 illustrates the example in which the rule is defined for each user, each user may be classified into a group in advance and a rule may be defined for each group. In this case, the CPU 21 executes the process content associated with the group to which the acquisition user belongs in accordance with the point.

In this manner, the administrator may set the rule for the group in the rule DB 18 instead of the rule for the user, or may set the rules for both the user and the group.

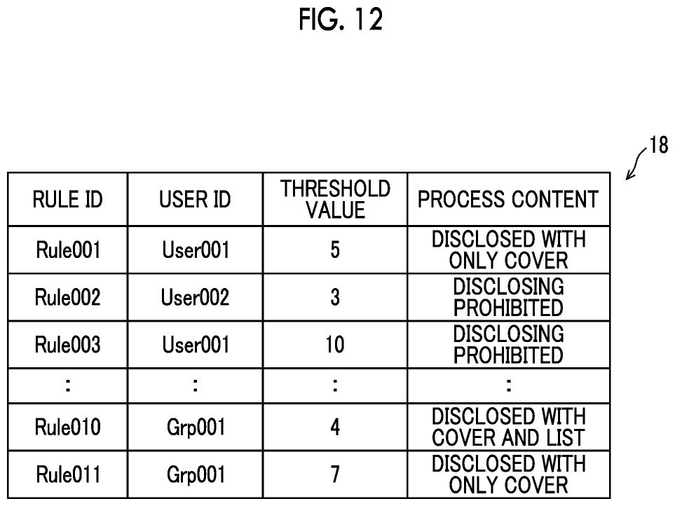

FIG. 12 is a diagram illustrating an example of the rule DB 18 in which rules for both a user and a group are set. The rule set in a user ID of “GrpNNN” (N is a number) is a rule applied to a user who belongs to a group NNN.

In the rule DB 18 illustrated in FIG. 12, for example, in a case where a user having a user ID represented by “User001” is a user who belongs to a group represented by “Grp001” and a point for an acquisition request is 6 points, both a rule defined for a user having a rule ID represented by “Rule001” and a rule defined for a group having a rule ID represented by “Rule010” are established. Even in such a case, the CPU 21 selects a rule with which the highest threshold value is associated, among the established rules. That is, the CPU 21 selects the rule having the rule ID represented by “Rule001”.

Although one aspect of the information processing apparatus is described above by using the exemplary embodiment, the form of the disclosed information processing apparatus is an example, and the form of the information processing apparatus is not limited to the scope described in the exemplary embodiment. Various modifications or improvements may be made to the exemplary embodiment without departing from the gist of the present disclosure, and the modified or improved forms are also included in the technical scope of the disclosure. For example, the order of the registration process and the acquisition process respectively illustrated in FIGS. 10 and 11 may be changed without departing from the gist of the present disclosure.

Further, in the exemplary embodiment described above, as an example, the form in which the registration process and the acquisition process are realized by software is described. Meanwhile, hardware may be used to perform the same process as the registration process and the acquisition process respectively illustrated in FIGS. 10 and 11. In this case, a processing speed may be increased as compared with the case where the registration process and the acquisition process are realized by the software.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above exemplary embodiment, the example in which the information processing program is stored in the ROM 22 is described, and the storage destination of the information processing program is not limited to the ROM 22. The information processing program of the present disclosure may also be provided in a form recorded on a storage medium readable by the computer 20. For example, the information processing program may be provided in a form of being recorded on an optical disk such as a compact disk read only memory (CD-ROM) and a digital versatile disk read only memory (DVD-ROM). Further, the information processing program may be provided in a form of being recorded in a portable semiconductor memory such as a USB memory and a memory card.

The ROM 22, the non-volatile memory 24, the CD-ROM, the DVD-ROM, the USB, and the memory card are examples of non-transitory storage media.

Further, the information processing apparatus may download an information processing program from an external apparatus connected to the communication unit 27 by a communication line 4, and store the downloaded information processing program in a non-transitory storage medium. In this case, the CPU 21 of the information processing apparatus reads the information processing program downloaded from the external apparatus from the non-transitory storage medium, and executes a notification process.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire a confidentiality value indicating a degree of confidentiality of a file on which an operation request is performed, by using at least one of an attribute of a user who performs the operation request on the file or file information of the file on which the operation request is performed; and
execute a process corresponding to the confidentiality value, on the file on which the operation request is performed, according to a predetermined regulation in which the confidentiality value and a process for the file are associated with each other.

2. The information processing apparatus according to claim 1, wherein the processor is configured to:
acquire a conditional equation in which the confidentiality value is associated with at least one of a user condition related to the attribute of the user or a file condition related to the file information, and
execute a process corresponding to a total value of the confidentiality values associated with each of the conditional equations satisfying the condition.

3. The information processing apparatus according to claim 2,
wherein the user condition includes a condition that defines a relationship between a user who registers the file on which the operation request is performed and the user who performs the operation request on the file, and
the file condition includes at least one of a condition that defines a text string used for a file name of the file on which the operation request is performed or a condition that defines a text string used for a content of the file on which the operation request is performed.

4. The information processing apparatus according to claim 3,
wherein the content of the file on which the operation request is performed is represented by at least one keyword extracted from a body of the file.

5. The information processing apparatus according to claim 1,
wherein the predetermined regulation is defined for each user, and
the processor is configured to:
execute the process corresponding to the confidentiality value, on the file on which the operation request is performed, according to the predetermined regulation defined for the user who performs the operation request on the file.

6. The information processing apparatus according to claim 2,
wherein the predetermined regulation is defined for each user, and
the processor is configured to:
execute the process corresponding to the confidentiality value, on the file on which the operation request is performed, according to the predetermined regulation defined for the user who performs the operation request on the file.

7. The information processing apparatus according to claim 3,
wherein the predetermined regulation is defined for each user, and
the processor is configured to:
execute the process corresponding to the confidentiality value, on the file on which the operation request is performed, according to the predetermined regulation defined for the user who performs the operation request on the file.

8. The information processing apparatus according to claim 4,
wherein the predetermined regulation is defined for each user, and
the processor is configured to:
execute the process corresponding to the confidentiality value, on the file on which the operation request is performed, according to the predetermined regulation defined for the user who performs the operation request on the file.

9. The information processing apparatus according to claim 5,
wherein the predetermined regulation is also defined for each group to which the user belongs,
in a case where the confidentiality value corresponds to both the predetermined regulation defined for the user who performs the operation request on the file and the predetermined regulation defined for a group to which the user who performs the operation request on the file belongs, the process corresponding to the confidentiality value is executed on the file on which the operation request is performed, according to the predetermined regulation under which a process having a higher degree of confidentiality of the file is performed.

10. The information processing apparatus according to claim 6,
wherein the predetermined regulation is also defined for each group to which the user belongs,
in a case where the confidentiality value corresponds to both the predetermined regulation defined for the user who performs the operation request on the file and the predetermined regulation defined for a group to which the user who performs the operation request on the file belongs, the process corresponding to the confidentiality value is executed on the file on which the operation request is performed, according to the predetermined regulation under which a process having a higher degree of confidentiality of the file is performed.

11. The information processing apparatus according to claim 7,
wherein the predetermined regulation is also defined for each group to which the user belongs,
in a case where the confidentiality value corresponds to both the predetermined regulation defined for the user who performs the operation request on the file and the predetermined regulation defined for a group to which the user who performs the operation request on the file belongs, the process corresponding to the confidentiality value is executed on the file on which the operation request is performed, according to the predetermined regulation under which a process having a higher degree of confidentiality of the file is performed.

12. The information processing apparatus according to claim 8,
wherein the predetermined regulation is also defined for each group to which the user belongs,
in a case where the confidentiality value corresponds to both the predetermined regulation defined for the user who performs the operation request on the file and the predetermined regulation defined for a group to which the user who performs the operation request on the file belongs, the process corresponding to the confidentiality value is executed on the file on which the operation request is performed, according to the predetermined regulation under which a process having a higher degree of confidentiality of the file is performed.

13. A non-transitory computer readable medium storing an information processing program causing a computer to execute a process comprising:
acquiring a confidentiality value indicating a degree of confidentiality of a file on which an operation request is performed, by using at least one of an attribute of a user who performs the operation request on the file or file information of the file on which the operation request is performed; and
executing a process corresponding to the confidentiality value, on the file on which the operation request is performed, according to a predetermined regulation in which the confidentiality value and a process for the file are associated with each other.

14. An information processing method comprising:
acquiring a confidentiality value indicating a degree of confidentiality of a file on which an operation request is performed, by using at least one of an attribute of a user who performs the operation request on the file or file information of the file on which the operation request is performed; and
executing a process corresponding to the confidentiality value, on the file on which the operation request is performed, according to a predetermined regulation in which the confidentiality value and a process for the file are associated with each other.
